(19) United States
(12) Patent Application Publication
(10) Pub. No.: US 2008/0308097 A1
(43) Pub. Date: Dec. 18, 2008

(54) METHOD AND APPARATUS FOR CLEARING BLOCKED FLUID PASSAGES IN THE HEAD

(76) Inventor: Michelle R. Silberstein, New York, NY (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/762,403

(22) Filed: Jun. 13, 2007

(51) Int. Cl. A62B 7/00

(52) U.S. Cl. 128/200.24

(57) ABSTRACT

Blocked fluid passages in the head are cleared by applying vibratory forces through the jawbone using a handheld appliance supporting a battery powered vibratory mechanism at one end of a handle and a mouthpiece at the other end.

### FIELD OF THE INVENTION

This invention relates to a method of clearing blocked fluid passages in the head, such as Eustachian tubes and sinus cavities, by inducing vibrations into the areas and more particularly, to an appliance for inducing such vibrations into the head through the dental cavity.

### BACKGROUND OF THE INVENTION

The Eustachian tubes can be blocked or obstructed for a variety of reasons, most often colds, sinus infections and nasal allergies. When a Eustachian tube is blocked, the middle ear pressure cannot be equalized and pressures are exerted on the eardrum. These pressures stretch the eardrum to prevent it from vibrating naturally, so sounds are blocked or muffled. A vacuum will often form behind the eardrum and draw fluids into the ear which can create potentially injurious ear infections.

Pain most often results from blocked Eustachian tubes when experiencing extreme pressure changes, such as occur in airplanes during take-off or landing, in elevators, or in diving. Even at constant air pressures, the blocked ears produce a very uncomfortable feeling.

Blocked ears may often be cleared by swallowing so as to activate the muscle that opens the Eustachian tube, or by chewing gum to constantly flex the ear muscles. Certain medications will dry up the ear so as to minimize Eustachian tube blockage, but they often have undesirable side effects. Similar problems result when the ostium of a sinus cavity is blocked.

### SUMMARY OF THE INVENTION

The present invention is accordingly directed toward a method of clearing blocked fluid passages in the head, including Eustachian tubes and sinus cavities, by applying vibratory forces into the head area and more particularly, to a device which may be inserted into the oral cavity so as to induce vibrations into the head and unblock the Eustachian tubes and sinus cavities.

The method of the present invention can be practiced through use of a novel device appliance which incorporates an elongated handle to allow insertion of a mouthpiece, supported at one end, into the oral cavity, where it may be pressed against the teeth or forced between the upper and lower jaws with a biting action. The device incorporates an electrically powered vibratory mechanism which is preferably adjustable in terms of both vibratory frequency and intensity. The device may include manual controls for adjusting the amplitude or frequency of the vibrating waves, or alternatively, energizing circuitry which automatically scans a variety of frequencies and intensities.

The device is preferably battery powered and in one embodiment, is used with a recharging stand in which the device may be supported when not in use.

The mouthpiece formed at one end of the elongated handle preferably extends laterally to the end of the handle so that it may be moved into an optimum location for inducing vibrations into the affected ear.

### BRIEF DESCRIPTION OF THE DRAWINGS

Other objects, advantages and applications of the present invention will be made clear by the following description of a preferred embodiment of the invention. The description makes reference to the attached drawings, in which:

FIG. 1 is a perspective view of a handheld device operative to be disposed in a user's oral cavity to impose vibratory forces onto one or both jaws and thus induce vibrations into the Eustachian tube adapted to clear blockages in the Eustachian tube;

FIG. 2 is a perspective view of the user applying the device to the jaw bone in order to induce vibrations into the head; and

FIG. 3 is a schematic diagram of the circuitry of the device of FIGS. 1 and 2.

### DETAILED DESCRIPTION OF THE PREFERRED EMBODIMENTS

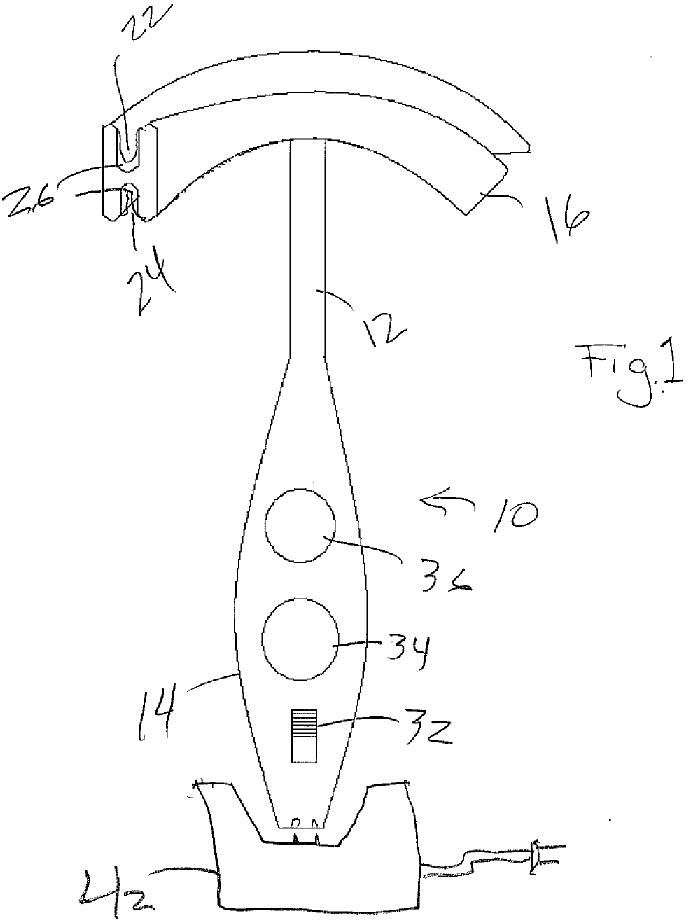

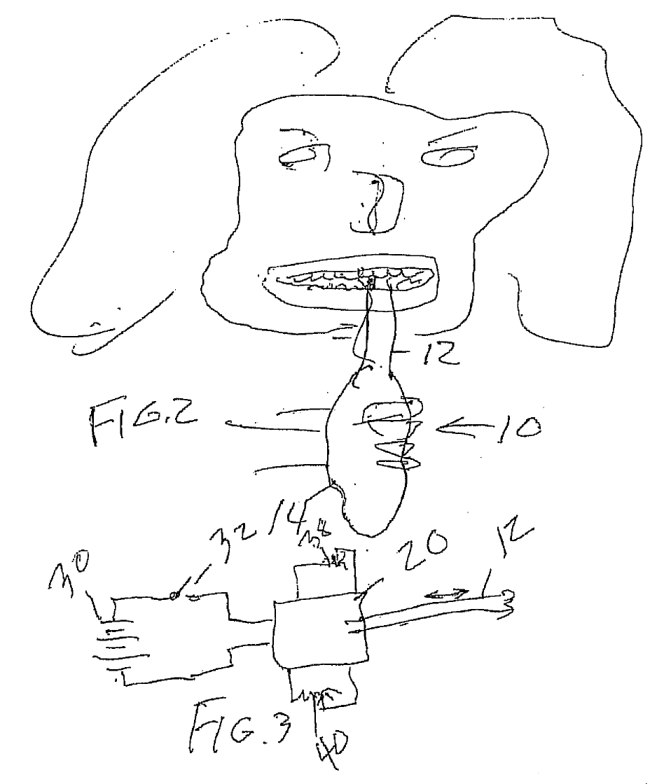

Referring to the drawings, a device formed in accordance with the present invention for practice of the present method is generally indicated at 10 in FIGS. 1 and 2. The device incorporates an elongated stem 12 having a hand grip 14 formed at one end and a mouthpiece 16 affixed to the other end. Mouthpiece 16 performs the function imparting vibrations generated by the device 10, through a vibrator 20 (FIG. 3) supported in the handle 14, into the teeth and thus the jawbone of a user and may take any of a variety of forms. In the preferred form, illustrated in FIG. 1, the mouthpiece 16 constitutes a substantially rigid elongated member, curved in the same manner as a typical dental arch. Its upper and lower surfaces are formed with grooves 22 and 24, respectively, which are adapted to engage these teeth. Either one may be brought into contact with one set of teeth, or the user may bite on the device 16 so the dental arch is resting in the grooves 22 or 24. The surfaces of the grooves 22 and 24 which contact the teeth are preferably aligned with a resilient material 26 to allow firm contact between the mouthpiece and the teeth without harming the teeth.

The stem 12 is affixed at one end of the mouthpiece 16 so that vibrations induced into the stem cause similar vibrations of the mouthpiece.

The handle member, formed at the other end of the stem 12, incorporates an electrically powered vibratory mechanism 20 which may be of any conventional design, such as an electromagnet contacting an armature as in a conventional vibrator. The stem 12 is affixed to the vibratory mechanism 20 so that the motions of the vibratory mechanism are induced into the stem. The unit is preferably powered by a battery 30 through a switch mechanism 32. The switch 32 may be accessed by the user through the handle. It may be placed in an on or off position, or in a position in which the vibratory mechanism 20 undergoes a cyclical vibration which may vary in frequency, intensity, or both. The handle 14 may incorporate dials 34 and 36, which control rheostats 38 and 40, connected to the vibratory mechanism so as to adjust the vibratory frequency and/or intensity. The user may vary these controls until an intensity and a frequency which achieves maximum relief of the pressure in the Eustachian tubes is noted.

As illustrated in FIG. 2, the user holds the device by the handle 14 with the mouthpiece in the oral cavity and adjusts the control so as to induce vibrations into the Eustachian tubes or sinus cavities through the jawbone.

The battery 30 is preferably rechargeable and is recharged between uses by supporting the handle 14 in a recharging stand 42.

Having thus described by invention, I claim:

1. The method of relieving blockage of head cavities comprising:
inducing vibrations into the user's jawbone which cause unblocking of the cavities.

2. A device for relieving the blockage of Eustachian tubes and sinus cavities comprising:
a mouthpiece, and means for vibrating the mouthpiece so as to induce vibrations into the jawbone and thus into the blocked areas.
